(19) United States
(12) Patent Application Publication
(10) Pub. No.: US 2008/0057294 A1
(43) Pub. Date: Mar. 6, 2008

(54) High impact polystyrene tile

(75) Inventors: Kenneth S. Laverdure, Lake Jackson, TX (US); Michael McLeod, Kemah, TX (US)

Correspondence Address: FINA TECHNOLOGY INC, PO BOX 674412, HOUSTON, TX, 77267-4412, US

(73) Assignee: FINA TECHNOLOGY, INC.

(21) Appl. No.: 11/514,497

(22) Filed: Sep. 1, 2006

(51) Int. Cl. B32B 27/00

(52) U.S. Cl. 428/319.3; 428/319.7; 428/320.2; 428/321.1

(57) ABSTRACT

This invention relates to tiles that are suitable directly for use in flooring, on bathroom and other walls, kitchen and bath countertops, table tops etc. The tile is composed of at least two layers. One layer is made essentially entirely of, or includes, high impact polystyrene foam. The other layer can be made of, or include, any thermoplastic polymer.

### CROSS REFERENCE TO RELATED APPLICATION

This application is related to copending U.S. application entitled, “Engravable Board” filed on Sep. 1, 2006, which is incorporated by reference herein.

### FIELD

This invention relates to tiles that are suitable directly for use in flooring, on bathroom and other walls, kitchen and bath countertops, table tops etc. The tile is composed of at least two layers. One layer is made essentially entirely of, or includes, high impact polystyrene foam. The other layer can be made of, or include, any thermoplastic polymer.

### BACKGROUND

Conventional tiles, such as ceramic, granite, and marble tiles, are expensive, heavy, and relatively difficult to install. They are difficult to manufacture, cut and transport. Once installed, they are difficult to replace, and they absorb little sound but a substantial amount of heat. Nevertheless, such tiles are extremely popular owing at least in part to their aesthetic appeal, durability and ease of maintenance.

There is a need, therefore, for inexpensive, durable and easily maintainable tile alternatives that are, for example, aesthetically appealing, cheaper, easier to install and/or replace. The present inventions provide such alternatives. In addition, the tiles described herein are generally easy to cut and trim, and may be easily modified either before or after installation for use in a wide variety of applications depending on the exact types of layers incorporated and/or surface treatments applied. Additionally, the tiles described herein are potentially recyclable and can, at least partly, incorporate recycled material.

### SUMMARY

The following embodiments, each of which may be combined with one or more of the others, are described:

a tile comprising, a first layer comprising foamed, high impact polystyrene; and a second layer comprising a thermoplastic polymer. The layers may be melt extruded;

a tile comprising a first layer consisting essentially of foamed, high impact polystyrene; and a second layer;

a tile consisting essentially of a first layer comprising foamed, high impact polystyrene; and a second layer comprising a thermoplastic polymer;

a tile consisting essentially of a first layer comprising foamed, high impact polystyrene; and a second layer comprising a thermoplastic polymer said second layer having a protective coating or protective top layer disposed thereon.

Additional layers such as one or more tie layers and/or barrier layers may be included.

The surface area of the tile may be no larger than 256 in².

The second layer may be colorable or colored.

The high impact polystyrene may have a notched Izod impact value at 73° F. as determined according to ASTM D-256 of at least 0.85 ft-lb/in.

The second layer may be chemically or mechanically manipulated to impart texture and/or to remove gloss.

The foam may comprise expanded microspheres.

### DESCRIPTION

Each of the inventions will now be described in greater detail, including specific embodiments, versions and examples, but the inventions are not limited to these embodiments, versions and examples, which are included to enable a person having ordinary skill in the art to make and use the inventions.

“Tile” is defined as a ready-to-install unit suitable for one or more of the conventional ceramic tile uses. Tiles of the invention may be used or intended for other, unconventional uses while still being suitable for one or more of the conventional ceramic tile uses (for example flooring, countertops, backsplash). Such embodiments do not depart from the scope of the invention as defined by one or more of the claims.

“Layer” is defined as a section that is different from an adjacent section.

“Foam” is defined as having gas and/or air cells that may be open or closed.

“Thermoplastic” is defined as having the property of softening or fusing when heated, and of hardening when cooled without undergoing an appreciable chemical change.

“Tie layer” is defined as a layer that binds or fuses itself with another layer, and/or that binds or fuses two or more other layers together.

“Barrier layer” is defined as a layer that wholly or partially prevents passage of one or more substances and/or energy and/or light.

“Protective coating” is defined as either a layer or a substance that serves to wholly or partially prevent passage of one or more substances and/or energy and/or light.

“Protective top layer” is defined as a barrier layer or protective coating on, or substantially near, the outer surface (the outer surface being the one closest to the viewer once the tile is installed).

“Melt extrusion” is defined as a process by which molten thermoplastic material is passed through a die or other orifice to form a film or sheet.

“Expanded microsphere” is defined as a polymer pellet of any shape containing gas or liquid that expands upon heating. These “expanded spheres” create a foam with the pellets becoming the cells of the foam structure.

Unless otherwise indicated, “polymer” includes all forms, for example, homopolymers, copolymers, terpolymers and blends made in-situ or by physical combination.

“High impact polystyrene” includes what is known in the art as medium impact polystyrene, and is defined as a rubber modified polystyrene having a notched Izod impact value at 73° F. of at least 0.80 ft-lb/in. as determined according to ASTM D-256.

The high impact polystyrene includes, but is not limited to, embodiments wherein the notched Izod impact value at 73° F. as determined according to ASTM D-256 is at least 0.85 ft-lb/in, 0.90 ft-lb/in, 0.95 ft-lb/in, 1.0 ft-lb/in, 1.5 ft-lb/in, 2.0 ft-lb/in, or 2.5 ft-lb/in; as well as embodiments wherein the notched Izod impact value ranges from: 0.85 to 3.5 ft-lb/in; 0.90 to 3.5 ft-lb/in; 0.95 to 3.5 ft-lb/in; 1.0 to 3.5 ft-lb/in; 1.5 to 3.5 ft-lb/in; or 1.5 to 2.5 ft-lb/in.

The high impact polystyrene includes, but is not limited to, embodiments wherein the melt flow (200/5.0 measured according to ASTM D-1238) ranges from 20.0 to 1.0 g/10 mm, from 15.0 to 1.0 g/10 mm, from 10.0 to 1.5 g/10 mm and from 5.0 to 2.5 g/10 mm.

The high impact polystyrene includes, but is not limited to, embodiments wherein the falling dart impact value (measured according to ASTM D-3029) ranges from 4 to 300 in-lb, from 5 to 200 in-lb, from 6 to 175 in-lb and from 10 to 150 in-lb.

The high impact polystyrene includes, but is not limited to, embodiments wherein the strength (according to ASTM D-638) ranges from 8000 psi to 2000 psi, from 5000 psi to 3000 psi, or from 4000 psi to 3000 psi.

The high impact polystyrene includes, but is not limited to, embodiments wherein the strength (according to ASTM D-790) ranges from 15,000 psi to 4,000 psi, from 15,000 psi to 5,000 psi, or from 15,000 psi to 6,500 psi; and the modulus (according to ASTMD-790) ranges from 2.0 psi to 5.0 psi (105), or from 3.0 psi to 4.0 psi (10⁵).

The high impact polystyrene includes, but is not limited to, embodiments wherein the modulus (according to ASTM D-638) ranges from 5.5 to 2.0 psi (10⁵), from 5.5 to 2.5 psi (10⁵), from 5.0 to 2.5 psi (10⁵), or from 3.0 to 4.0 psi (105).

The high impact polystyrene includes, but is not limited to, embodiments wherein the elongation (according to ASTM D-638) ranges from 30% to 70%, from 35% to 65%, or from 40% to 60%.

The high impact polystyrene includes, but is not limited to, embodiments wherein the heat distortion (° F.) Annealed (according to ASTM D-648) is from 150 to 300, from 175 to 275, from 185 to 250, or from 190 to 225.

The high impact polystyrene includes, but is not limited to, embodiments wherein the Vicat softening (° F.) is from 150 to 300, from 175 to 275, from 180 to 250, from 185 to 225, or from 190 to 220.

In some embodiments, the first (high impact polystyrene foam) layer comprises at least 50%, 55%, 60%, 65% 70%, 75%, 80%, 85%, 90%, or 95%, by weight (based on the total weight of the first layer) high impact polystyrene foam. In some embodiments, this layer may comprise from: 50% to 100%; or 50% to 99%; 55% to 99% or 100%; 60% to 99% or 100%; 65% to 99% or 100%; 70% to 99% or 100%; 75% to 99% or 100%; 80% to 99% or 100%; 85% to 99% or 100%; or 90% to 99% or 100% high impact polystyrene foam.

Melt extrusion, particularly coextrusion, produces sheet with multiple layers present. Each layer is optically distinct from the surrounding sheet. Each layer may be the result of separate extruders or splitting of polymer melt streams in a feedblock.

Thus the amount of each layer in a tile may be determined on a volume rather than weight basis. The measurement of layer volume is determined by an optical technique. A section of sheet is submitted for analysis by optical microscopy. The sheet is microtomed into thin sections suitable for visible light to pass through. The sections are imaged on an optical microscope. The thickness of each layer is measured by imaging software or through a gradated eyepiece. Given that each layer has the same unit area, the thickness of each layer directly yields the relative volume of each layer. For example, a layer with 5% of the overall thickness will have 5% of the volume of a sheet.

The thermoplastic polymer, and/or polymer layers, may comprise, or consist essentially of, high impact polystyrene as described above. The layer containing the thermoplastic polymer, in one embodiment, is the outer layer visible to the human eye, or is among the outer layers whether or not visible.

In some embodiments, the second (thermoplastic polymer) layer comprises at least 50%, 55%, 60%, 65% 70%, 75%, 80%, 85%, 90%, or 95%, by weight (based on the total weight of the second layer) thermoplastic polymer, for example, high impact polystyrene. In some embodiments, this layer may comprise from: 50% to 100%; 50% to 99%; 55% to 99% or 100%; 60% to 99% or 100%; 65% to 99% or 100%; 70% to 99% or 100%; or 75% to 99% or 100%; or 80% to 99% or 100%; 85% to 99% or 100%; or 90% to 99% or 100% high impact polystyrene foam.

Examples of, and methods of making, high impact polystyrene and foams comprising high impact polystyrene are well-known and include, but are in no way limited to, those described in (each fully incorporated herein by reference): U.S. Patent Application Nos. 20050277754, 20050161858, 20050070662, 20040225023; and U.S. Pat. Nos. 6,982,309; 6,822,046; 6,437,043; 6,274,641; 6,489,378, 6,380,305; 5,354,402; 4,777,210; 6,613,837; 6,569,941; 6,972,311; 7,041,733; 6,770,716; 6,353,066; 4,062,712; 5,629,364; 5,520,961; 6,617,364; 6,638,984; 5,264,467; 6,007,830; 6,169,138; 4,891,387; 5,565,154; 5,549,968; 5,418,257; and 5,456,900.

References demonstrating how to use expandable microspheres include (each fully incorporated herein by reference): U.S. Pat. Nos. 3,615,972; 6,235,800; 6,022,912; 6,451,865; 5,780,523; 6,207,730; 6,582,633; 5,780,523; 5,629,364; 5,520,961; 6,617,364; 6,638,984; 5,264,467; 6,007,830; 6,169,138; 4,891,387; 5,565,154; 5,549,968; 5,418,257; 5,456,900 and United States Patent Application Nos. 20020132100; and EP 486080; and http://www.expancel.com.

Patents describing how to make expandable microspheres include U.S. patent Nos. (each fully incorporated herein by reference): U.S. Pat. Nos. 3,945,956; 5,536,756; 6,235,394; 6,509,384; 5,155,138; 5,834,526; 5,484,815; 5,585,119; 5,071,606; 6,903,143; 6,509,384; 5,719,247; 5,631,323; and 4,722,943.

In one embodiment, the first (high impact polystyrene foam) layer comprises at least 50%, 55%, 60%, 65% 70%, 75%, 80%, 85%, 90%, or 95%, by weight (based on the total weight of the first layer) high impact polystyrene foam.

In some embodiments, the high impact polystyrene, regardless of which layer or layers in which it is used, comprises, or consists essentially of, expanded microspheres.

Suitable high impact polystyrenes are commercially available from suppliers such as Total Petrochemicals, USA, Inc., Ineos Styrenics, Nova Chemicals, Dow Chemical company, Chevron Phillips Chemical Company and Huntsman Corporation.

Among the advantages of some embodiments of the inventions is that scrap (reclaim, regrind etc.) material can be used in one or more layers, and that the tiles may be wholly or partially recyclable. See U.S. Pat. Nos. 5,601,912 and 5,354,402 (both fully incorporated herein by reference.)

Various embodiments include, but are not limited to, those wherein one or more layers are either colorable via any means of applying or incorporating pigment on or into the layer either before or after installation, or colored before or after installation. Also included are embodiments wherein the second, thermoplastic layer is suitable for applying a decorative layer or image thereon, for example, a photograph as described in U.S. Pat. No. 5,863,632 (fully incorporated herein by reference), or some other image fixed to a substrate that can be secured onto this second layer.

In various embodiments, the second layer, or thermoplastic polymer layer, can be textured, for example by embossing or stamping, and/or can be made suitable for applying an additional layer or substance for imparting texture.

Other layers may be fully incorporated into or on the tile, for example, one or more protective layers, to impart properties as needed for various tile uses, such as, chemical, moisture, or stain resistance. Other layers can be applied or fully incorporated to impart, for example, strength, gloss, stability, heat resistance etc. “Tie” or adhesive layers can be used in or on the tile to bind or strengthen binds between the layers, or to facilitate installation, or to facilitate subsequent decoration. For example, some embodiments include tiles comprising adhesive or adhesive strips on either the “bottom” or “top” side wherein the adhesive comprises one or more chemical compounds, and/or wherein the “adhesive” comprises mechanical fasteners such as Velcro™, studs, screws, nails, clips etc.

Examples of tie layers include, but are not limited to embodiments comprising one or more functional groups, which may be of a polar or nonpolar nature. The functional groups may be added as a comonomer or grafted onto the existing polymer. A tie layer may be comprised of polymer with one or more distinct monomer units. Multiple monomer units may be arranged as blocks, statistical distributions, or random distributions. Tie layers may comprise one or more distinct phases.

Nonlimiting examples of tie layers include: block copolymers with two distinct phases and polymers with polar groups present. Styrene-butadiene-styrene (SBS) triblock copolymers are one example, where Finaclear from TOTAL PETROCHEMICALS and K-resin from Chevron Phillips are commercial examples. Tie layers may also use polar (acid) groups to increase adhesion. Primacor™ from Dow Chemical is poly(ethylene-co-acrylic acid), and Nucrel™ from Dupont is poly(ethylene-co-methacrylic acid). Tie layers may also be in neutralized form, such as Surlyn™ from Dupont. Surlyn™ is poly(ethylene-co-methacrylic acid) with a percentage or all acid groups replaced by melt salts.

The tile, in various embodiments, can be manufactured to include adhesives or fasteners as described above, and/or may be shaped to ease installation, for example with tongue-in-groove elements, or various types of flanges to allow for easy installation.

The tile may be manufactured to any shape for either functional or decorative purposes. For example, the tile edges may be smooth, rough, or have a chipped appearance. The overall shape may be, for example, round, square, hexagonal, rectangular etc. (long rectangular planks, such as are used in conventional wood or wood-like laminates are contemplated). The tile can be large or very small, for example, for use in mosaic designs. Also, in various embodiments, the tile “surface,” for example the second thermoplastic layer, can be made to look like any conventional flooring such as ceramic tile, slate tile, vinyl tile, marble, wood, linoleum etc. regardless of shape.

The tiles are ready-to-install units that may be combined to form the desired function or effect, rather than used as an entire sheet on a wall, floor, counter, etc. In some embodiments, the tile is no larger than 1024 in², 625 in², 256 in², or 144 in².

The material as described above for use in tiles can also be used as a single, large sheet that is cut to fit an entire kitchen countertop, island or backsplash, or a kitchen or bathroom wall section, or a table top, for example.

Additionally, embellishments, such as metal studs of various shapes, can be easily installed in or on the tile either before or after installation.

The tile may be cut from sheets prepared by coextrusion and/or extrusion coating to combine the first foam layer, the second thermoplastic layer and/or other layers or substances. Many suitable extrusion coating and coextrusion methods are well known in the art and include, but are not limited to, those described in U.S. patent No. (fully incorporated by reference): U.S. Pat. No. 5,354,402.

### EXAMPLES

### Example #1

Foamed tiles were first produced in the form of multiple layer foamed sheet. A four layer structure was produced on a Welex coextruder using melt extrusion techniques commonly known to the art. Foaming of the core layer was accomplished with techniques commonly known to the art. Examples of foam extrusion techniques may be found in “Thermoplastic Foam Extrusion” by James L. Throne (fully incorporated herein by reference).

The structure of the sheet was as follows. The bottom layer was TOTAL PETROCHEMICALS HIPS 740 with white colorant added via masterbatch. The foamed core was TOTAL PETROCHEMICALS HIPS 740 foamed using a chemical blowing agent, Safoam™ FP-40 from Reedy International. The upper colored layer was TOTAL PETROCHEMICALS HIPS 740 with red colorant added via masterbatch. The top layer was TOTAL PETROCHEMICALS general-purpose polystyrene 524, a gloss enhancing layer. The overall structure was foamed to a gauge at or exceeding 2.5 mm (0.100 inches).

Tiles were then stamped to the desired size using a mechanical press from the mother sheet. For the purposes of this example, tiles were cut to 8.5 cm (3.35 inches) by 8.5 cm. (FP-40 was used from 1% to 2% by weight.)

### Example #2

The same manufacturing procedures and polymers were used to produce foamed sheet as in Example #1. The difference lies in the use of expandable microspheres, in particular Expancel 950 MB 120 from Akzo-Nobel. Melt extrusion techniques for the use of Expancel are very similar to melt extrusion techniques for solids which are known in the art. (Expancel was used from 1% to 3% by weight.).

### Example #3

The tile of this example was produced using a Welex coextruder using techniques similar to those employed in Example #1. The sheet was comprised of a three layer structure. The outer layers were TOTAL PETROCHEMICALS HIPS 825E with white colorant added via masterbatch. The core was TOTAL PETROCHEMICALS HIPS 825E foamed with Safoam™ FP-40, a chemical blowing agent from Reedy International. The overall structure was foamed to a gauge at or exceeding 2.5 mm (0.100 inches). (FP-40 was used from 1% to 2% by weight.)

### Example #4

Three Total Petrochemicals polystyrenes, HIPS 740, HIPS 819E, and GPPS 524, were used in five different coextruded sheet samples. Sheet extrusion of an A-B-C-D structure was conducted on the Welex Coextrusion Line. Four of the extruders were employed as follows:
A) Outer cap layer—South 2½ Inch Extruder
B) Red cap layer—2 Inch Extruder
C) Foamed core—3 Inch Main Extruder
D) Inner white layer—North 2½ Inch Extruder

### The samples are given in Table I with the blowing agent and resin employed in each layer.

TABLE 1
Structure and blowing agents employed in each sample.

| | Sample | | | | | |
|---|---|---|---|---|---|---|
| | 1 | 2a | 2b | 3 | 4 | 5 |
| Layer A - Cap | Total 524 | Total 524 | Total 524 | Total 524 | Total 819E | Total 819E |
| Layer B - Red | Total 740 | Total 740 | Total 740 | Total 740 | Total 740 | Total 740 |
| Layer C - Foam | Total 740 | Total 740 | Total 740 | Total 740 | Total 740 | Total 740 |
| Layer D - White | Total 740 | Total 740 | Total 740 | Total 740 | Total 819E | Total 740 |
| Foaming agent | None | FP-40 | FP-40 | 95 MB 120 | 95 MB 120 | 95 MB 120 |
| Foaming agent, wt % | None | 1 | 1 | 3 | 3 | 3 |

TABLE 2
Gauge distribution and density reduction of each sample. The letters in
parentheses next to each layer were its assigned place in the overall structure.

| | Sample | | | | | | | | | | | |
|---|---|---|---|---|---|---|---|---|---|---|---|---|
| | 1 | | 2a | | 2b | | 33 | | 4 | | 5 | |
| | mil | % | mil | % | mil | % | mil | % | mil | % | mil | % |
| Cap Layer Gauge (A) | | | 4 | 3 | 4 | 4 | 7 | 6 | 3 | 2 | 6 | 5 |
| Red Layer Gauge (B) | | | 10 | 9 | 11 | 9 | 9 | 8 | 9 | 8 | 7 | 6 |
| Foamed Core Gauge (C) | | | 86 | 78 | 99 | 77 | 79 | 73 | 94 | 80 | 94 | 82 |
| White Layer Gauge (D) | | | 11 | 10 | 13 | 10 | 14 | 13 | 13 | 11 | 7 | 6 |
| Total Guage | 57 | | 110 | | 128 | | 108 | | 118 | | 114 | |

| | | | | | | |
|---|---|---|---|---|---|---|
| Foamed (Experimental) | 11.02⁴ | 14.40 | 17.04 | 15.53 | 16.32 | 16.18 |
| Coupon Weight, g | | | | | | |
| Solid (Theoretical) Coupon | 10.88⁴ | 20.99 | 24.43 | 20.61 | 22.52 | 21.76 |
| Weight,^{1,2} g | | | | | | |
| Ave. Coupon Gauge,³ mm | 1.45⁴ | 2.79 | 3.25 | 2.74 | 2.99 | 2.90 |
| Total Density (Weight) | 1.3%⁴ | 31.4% | 30.2% | 24.7% | 27.5% | 25.6% |
| Reduction | | | | | | |
| Total Density, g/cc | 1.05⁴ | 0.713 | 0.725 | 0.784 | 0.754 | 0.773 |
| Foamed (Experimental) | | 9.75 | 11.66 | 9.95 | 11.64 | 12.38 |
| Core Weight,⁵ g | | | | | | |
| Solid (Theoretical) Core | | 16.34 | 19.05 | 15.03 | 17.85 | 17.96 |
| Weight,^{1,2} g | | | | | | |
| Ave. Core Gauge,³ mm | | 2.18 | 2.54 | 2.00 | 2.38 | 2.39 |
| Core Density (Weight) | N/A | 40.3% | 38.8% | 33.8% | 34.7% | 31.1% |
| Reduction | | | | | | |
| Core Density, g/cc | N/A | 0.620 | 0.637 | 0.688 | 0.679 | 0.717 |

¹⁾Theoretical weight = 1.04 g/cc (PS density) × 72.25 cm² (coupon area) × coupon gauge.
²⁾Density of color concentrate was assumed to be the same as density of polystyrene.
³⁾Average gauge was calculated by measuring the gauge at each corner of the coupon.
⁴⁾Calculations for sample 1 were employed to determine the error in density measurements. An error of 1.3% was computed based on 1.04 g/cc as the accepted density of the sheet.
⁵⁾The weight of the foamed core was obtained by subtracting the weight of the caps, as calculated by 1.04 g/cc (PS density) × 72.25 cm² (coupon area) × combined gauge of all cap layers.

TABLE 3
Core layer data (gauge, coupon mass, and density reduction) on all
foamed samples.

| | Sample | | | | |
|---|---|---|---|---|---|
| | 2a | 2b | 3 | 4 | 5 |
| Foamed | 9.75 | 11.66 | 9.95 | 11.64 | 12.38 |
| (Experimental) Core | | | | | |
| Weight, g | | | | | |
| Ave. Core Gauge, mils | 86 | 99 | 79 | 94 | 94 |
| Core Density (Weight) | 40.3% | 38.8% | 33.8% | 34.7% | 31.1% |
| Reduction | | | | | |

Compression testing was done on the samples according to ASTM D-1621-00, however, with a maximum of 1000 lbs of force that could be applied, none of the samples failed.

While the foregoing is directed to certain embodiments of the present invention, other and further embodiments of the invention may be devised without departing from the basic scope thereof, and the scope thereof is determined by the claims that follow.

1. A tile comprising: a first layer comprising foamed, high impact polystyrene; and a second layer comprising a thermoplastic polymer.

2. The tile of claim 1 wherein at least one of the layers is melt extruded.

3. The tile of claim 1 wherein the two layers are adhered to one another by melt extrusion.

4. The tile of claim 1 further comprising a tie layer and/or a barrier layer.

5. The tile of claim 1 having a surface area no larger than 256 in².

6. The tile of claim 1 wherein the second layer is colorable.

7. The tile of claim 1 wherein the second layer is colored.

8. The tile of claim 1 wherein the high impact polystyrene has a notched Izod impact value at 73° F. as determined according to ASTM D-256 of at least 0.85 ft-lb/in.

9. The tile of claim 1 wherein the second layer has been chemically or mechanically manipulated to impart texture and/or gloss and/or to remove gloss.

10. The tile of claim 1 wherein the foam comprises expanded microspheres.

11. A tile comprising: a first layer consisting essentially of foamed, high impact polystyrene; and a second layer.

12. The tile of claim 11 wherein at least one of the layers is melt extruded.

13. The tile of claim 11 further comprising a tie layer or a barrier layer.

14. The tile of claim 11 having a surface area no larger than 256 in².

15. The tile of claim 11 wherein the second layer is colorable.

16. The tile of claim 11 wherein the second layer is colored.

17. The tile of claim 11 wherein the high impact polystyrene has a notched Izod impact value at 73° F. as determined according to ASTM D-256 of at least 0.85 ft-lb/in.

18. The tile of claim 11 wherein the second layer has been chemically or mechanically manipulated to impart texture and/or gloss and/or to remove gloss.

19. The tile of claim 11 wherein the foam comprises expanded microspheres.

20. A tile consisting essentially of: a first layer comprising foamed, high impact polystyrene; and a second layer comprising a thermoplastic polymer.

21. The tile of claim 20 wherein at least one of the layers is melt extruded.

22. The tile of claim 20 further comprising a tie layer and/or a barrier layer.

23. The tile of claim 20 having a surface area no larger than 256 in².

24. The tile of claim 20 wherein the second layer is colorable.

25. The tile of claim 20 wherein the second layer is colored.

26. The tile of claim 20 wherein the high impact polystyrene has a notched Izod impact value at 73° F. as determined according to ASTM D-256 of at least 0.85 ft-lb/in.

27. The tile of claim 20 wherein the second layer has been chemically or mechanically manipulated to impart texture and/or gloss and/or to remove gloss.

28. The tile of claim 20 wherein the foam comprises expanded microspheres.

29. A tile consisting essentially of: a first layer comprising foamed, high impact polystyrene; and a second layer comprising a thermoplastic polymer said second layer having a protective coating or protective top layer disposed thereon.

30. The tile of claim 29 wherein at least one of the layers is melt extruded.

31. The tile of claim 29 further comprising a tie layer and/or a barrier layer.

32. The tile of claim 29 having a surface area no larger than 256 in².

33. The tile of claim 29 wherein the second layer is colorable.

34. The tile of claim 29 wherein the second layer is colored.

35. The tile of claim 29 wherein the high impact polystyrene has a notched Izod impact value at 73° F. as determined according to ASTM D-256 of at least 0.85 ft-lb/in.

36. The tile of claim 29 wherein the foam comprises expanded microspheres.

37. The tile of claim 29 wherein the second layer has been chemically or mechanically manipulated to impart texture and/or gloss and/or to remove gloss.
